(19) United States
(12) Patent Application Publication
(10) Pub. No.: US 2020/0255250 A1
(43) Pub. Date: Aug. 13, 2020

(54) PAPER TRANSPORT DEVICE AND IMAGE FORMING APPARATUS

(71) Applicant: FUJI XEROX CO., LTD., Tokyo (JP)

(72) Inventors: Mizuki ARAI, Kanagawa (JP); Akira Iwasaka, Kanagawa (JP); Junichi Asaoka, Kanagawa (JP); Yuki Sekura, Kanagawa (JP); Hiromitsu Tomioka, Kanagawa (JP); Teruki Naganuma, Kanagawa (JP); Keita Yano, Kanagawa (JP); Kohei Takahashi, Kanagawa (JP); Yuichiro Shimura, Kanagawa (JP)

(73) Assignee: FUJI XEROX CO., LTD., Tokyo (JP)

(21) Appl. No.: 16/522,006

(22) Filed: Jul. 25, 2019

(30) Foreign Application Priority Data
Feb. 13, 2019 (JP) 2019-023103

(51) Int. Cl. B65H 29/52; B65H 29/12; B65H 29/60; G03G 15/00

(52) U.S. Cl. CPC B65H 29/52; B65H 29/125; B65H 2801/06; G03G 15/6529; B65H 2402/45; B65H 29/60

(57) ABSTRACT

A paper transport device includes: a paper transport path that includes plural pairs of transport units provided in a direction intersecting with a direction of transport of paper, and transports paper in a predetermined direction; an opening and closing unit that is opened and closed to expose a part of the paper transport path; and a guide unit that has a guide surface on one side of the paper transport path and is rotatably supported about a rotation shaft between a guide posture for guidance of the paper and an opening posture for opening of the guide surface through rotation from the guide posture, when the opening and closing unit is opened.

### CROSS-REFERENCE TO RELATED APPLICATIONS

This application is based on and claims priority under 35 USC 119 from Japanese Patent Application No. 2019-023103 filed Feb. 13, 2019.

### BACKGROUND

### (i) Technical Field

The present disclosure relates to a paper transport device and an image forming apparatus.

### (ii) Related Art

There is known a sheet transport device including a sheet transport path along which a sheet is transported; an upstream transport member disposed upstream of the sheet transport path in the sheet transport direction; a downstream transport member disposed downstream of the sheet transport path in the sheet transport direction; and a control unit that drives the upstream transport member so that the sheet is transported in the sheet transport direction and drives the downstream transport member so that the sheet is transported in the direction opposite to the sheet transport direction in a case where the sheet transported in the sheet transport path is jammed (Japanese Patent Application No. 2005-077895 (Patent Document 1)).

There is known a recording material transport device including a transport path portion that transports a recording material on which an image is formed; a first opening and closing portion that is provided on one side of the own device so as to be able to open and close to the own device and opens a part of the transport path portion by opening to the own device; and a second opening and closing portion that is provided inside the own device from the first opening and closing portion so as to be able to open and close to the own device and opens another part of the transport path portion which is different from the one part of the transport path portion by opening to the own device (Japanese Patent Application No. 2017-061356 (Patent Document 2).

### SUMMARY

Aspects of non-limiting embodiments of the present disclosure relate to providing a paper transport device that is capable of stably transporting paper even when configured to have a paper transport path openable for easy removal of jammed paper in contrast to a case where there is no configuration in which a guide unit rotatably moves in a direction of transport of the paper, and to an image forming apparatus.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a paper transport device including: a paper transport path that includes plural pairs of transport units provided in a direction intersecting with a direction of transport of paper, and transports paper in a predetermined direction; an opening and closing unit that is opened and closed to expose a part of the paper transport path; and a guide unit that has a guide surface on one side of the paper transport path and is rotatably supported about a rotation shaft between a guide posture for guidance of the paper and an opening posture for opening of the guide surface through rotation from the guide posture, when the opening and closing unit is opened.

### BRIEF DESCRIPTION OF THE DRAWINGS

Exemplary embodiments of the present invention will be described in detail based on the following figures, wherein:

FIG. 1 is a schematic sectional view illustrating an internal configuration of an image forming apparatus;

FIG. 2 is a schematic sectional view illustrating a paper transport path in a paper transport device;

FIG. 3A is a schematic sectional view illustrating the paper transport path in the paper transport device in which a second guide is positioned at an opening posture, and FIG. 3B is a diagram illustrating the distance between a pair of transport rollers;

FIG. 4A is a schematic sectional view illustrating a state where the guide is returning from the opening posture to a guide posture, and FIG. 4B is a diagram illustrating distance between a pair of transport rollers;

FIG. 5A is a schematic sectional view illustrating a state where the guide is positioned in the guide posture, and FIG. 5B is a diagram illustrating a nip state of the pair of transport rollers;

FIG. 6 is a schematic sectional view illustrating a movement start position in a case where the guide is moved to the guide posture;

FIG. 7 is a schematic sectional view illustrating a state where the guide comes into contact with the second guide to return the second guide to the guide position;

FIG. 8 is a schematic sectional view illustrating a state where the guide and an opening and closing member are engaged with an apparatus main body; and

FIG. 9 is a schematic sectional view of an image forming apparatus in which the guide is positioned in the opening posture by opening the opening and closing member.

### DETAILED DESCRIPTION

Next, with reference to the drawings, the present disclosure will be described in more detail with exemplary embodiments and specific examples below; however, the present disclosure is not limited to these exemplary embodiments and examples.

Further, in the following description using the drawings, the drawings are schematic and the ratio of each dimension is different from the actual one, and for the sake of easy understanding, illustration of members other than those necessary for description is appropriately omitted.

(1) Overall Configuration and Operation of Image Forming Apparatus

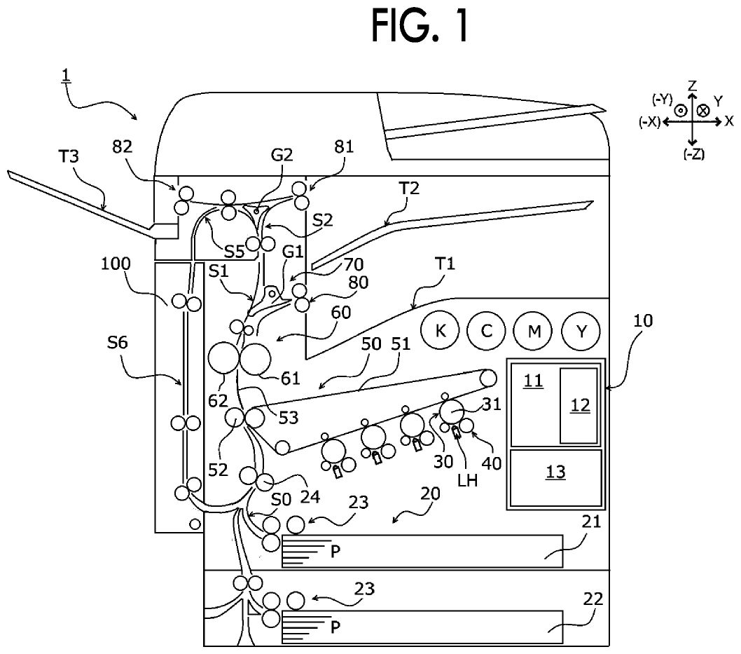

FIG. 1 is a schematic sectional view illustrating an internal configuration of an image forming apparatus 1.

Hereinafter, the overall configuration and operation of the image forming apparatus 1 are described with reference to the drawings.

The image forming apparatus 1 is configured to include a control device 10, a paper feeding device 20, an exposure device LH, a photosensitive unit 30, a developing machine 40, a transfer device 50, a fixing device 60, and a paper transport device 70. An ejection tray T1 of paper P on which an image is recorded is ejected and accommodated is formed on an upper surface (Z direction) of the image forming apparatus 1.

The control device 10 includes a controller 11 that controls an operation of the image forming apparatus 1, an image processing unit 12 that controls an operation by the controller 11, a power supply device 13, and the like. The power supply device 13 applies a voltage to a photosensitive unit 30, a developing machine 40, a transfer device 50, and the like.

The image processing unit 12 outputs a driving signal to an exposure device LH by converting print information input from an external information transmission device (for example, a personal computer or the like) into image information for forming a latent image at a timing previously set.

A paper feeding device 20 including paper trays 21 and 22 are provided at a bottom of the image forming apparatus 1, and the paper P whose position in a width direction has been determined by a restriction plate (not shown) is drawn to the side (−X direction) by the paper drawer 23 from the upper side one by one.

The paper P drawn from the paper drawer 23 is transported to a nip portion of a pair of registration rollers 24 via a paper transport path S0.

Each of the photosensitive unit 30 is provided in parallel above (Z direction) the paper feeding device 20 and includes a photosensitive drum 31 which is rotationally driven. Each of toner images of yellow (Y), magenta (M), cyan (C), and black (K) is formed on each of the photosensitive drums 31 by the developing machine 40.

The toner image of each color formed on the photosensitive drum 31 of the photosensitive unit 30 is sequentially transferred (primary transfer) onto the intermediate transfer belt 51 of the transfer device 50 so as to form a superimposed toner image in which the toners of the respective colors are superimposed. The superimposed toner image on the intermediate transfer belt 51 is sent from the pair of registration rollers 24, and is collectively transferred to the paper P guided by the transport guide by a secondary transfer roller 52.

The fixing device 60 includes a fixing nip portion (fixing region) which is formed of a pressed region of a pair of heating modules 61 and pressure module 62.

The paper P having the toner image collectively transferred in the transfer device 50 is transported to the fixing nip portion of the fixing device 60 via a transport guide 53 in a state where the toner image is unfixed, and then heated and pressured by the pair of the heating module 61 and pressure module 62 to fix the toner image.

The paper P on which the fixed toner image is formed is guided to a first transport path S1 of the paper transport device 70, and ejected from a pair of first ejection rollers 80 and accommodated in the ejection tray T1 on the upper surface of the image forming apparatus 1. In a case where the paper is reversed for double-sided printing or ejected with the image recording surface up, the transport direction is switched at a switching gate G1 toward a second transport path S2.

In the second transport path S2, a face-down ejected paper which is ejected with the image recording surface down from a pair of second ejection rollers 81 and loaded to an ejection tray T2, and a face-up ejected paper which is ejected with the image recording surface up from a pair of third ejection rollers 82 and loaded to an ejection tray T3 are switched over at a switching gate G2.

In addition, in a case of double-sided printing, the pair of second ejection rollers 81 are reversely driven, and the reversed paper P is transported again to the pair of registration rollers 24 to form an image on a back surface.

(2) Configuration and Operation of Paper Transport Device

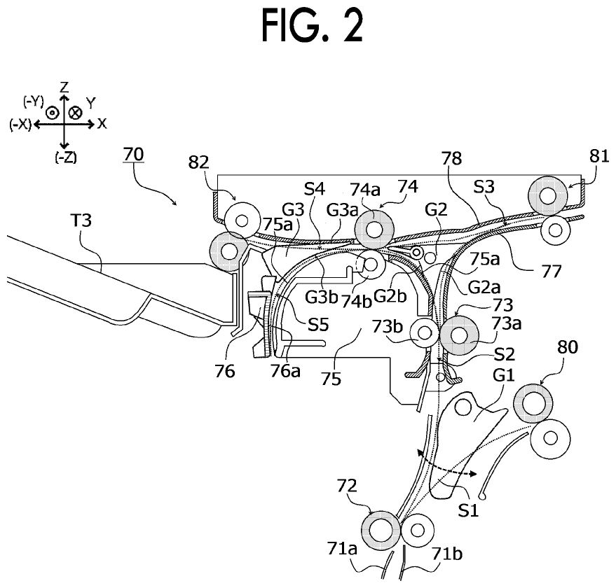

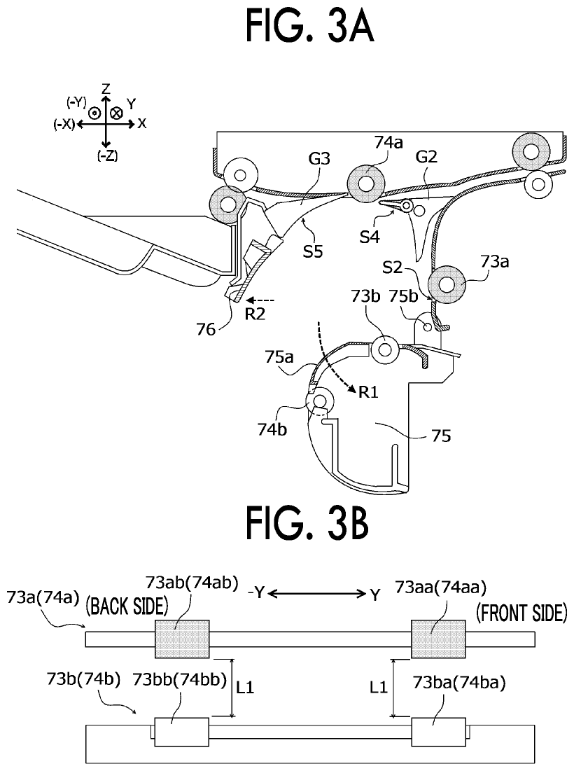

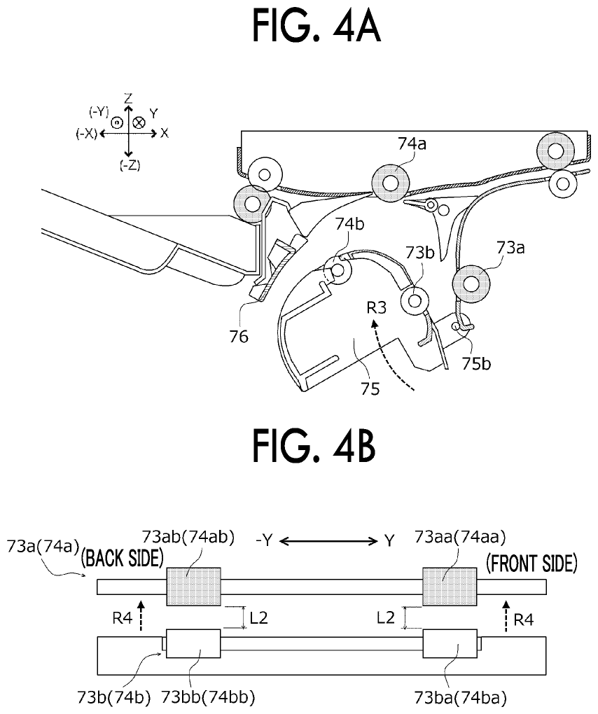

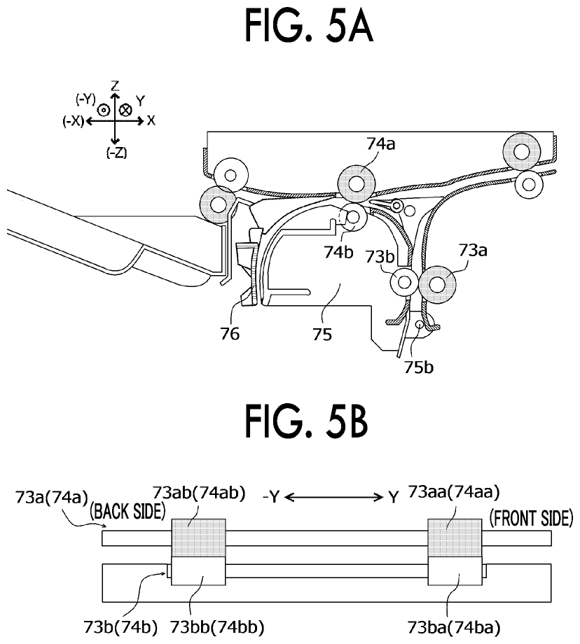

FIG. 2 is a schematic sectional view illustrating a paper transport path in a paper transport device 70, FIG. 3 is a schematic sectional view illustrating the paper transport path in the paper transport device 70 in which a second guide 76 is positioned at an opening posture, FIG. 4A is a schematic sectional view illustrating a state where a guide 75 is returning from the opening posture to a guide posture, and FIG. 4B is a diagram illustrating distance between a pair of transport rollers 73 and 74, and FIG. 5A is a schematic sectional view illustrating a state where the guide 75 is positioned in the guide posture, and FIG. 5B is a diagram illustrating a nip state of the pair of transport rollers 73 and 74.

Hereinafter, the configuration of the paper transport device 70 of the image forming apparatus 1 and paper transport will be described with reference to the drawings.

(2.1) Configuration of Paper Transporting Unit

As illustrated in FIG. 2, the paper transport device 70 includes guides 71a and 71b provided downstream of the fixing device 60 in paper transport direction, a pair of transport rollers 72, 73, and 74, switching gates G1, G2, and G3, a pair of first ejection rollers 80, a pair of second ejection rollers 81, a pair of third ejection rollers 82, a guide 75 as an example of a guide unit, and a second guide 76 as an example of a second guide unit.

The guides 71a and 71b are provided downstream of the fixing nip portion of the fixing device 60, and guide the paper P on which the toner image is fixed to the pair of transport rollers 72. A first transport path S1 from the pair of transport rollers 72 to the pair of first ejection rollers 80 is formed of the switching gate G1.

The switching gate G1 is rotatably supported so as to take a first position for guiding paper P to the pair of first ejection rollers 80 and a second position for guiding the paper P to the pair of transport rollers 73 (refer to arrows in FIG. 2).

In a state where the switching gate G1 is positioned in the first position for guiding the paper P to the pair of first ejection rollers 80, the first transport path S1 from the pair of transport rollers 72 to the pair of first ejection rollers 80 is formed in a curved state and thus an increase in the height of the device is suppressed.

The second transport path S2 is formed downstream of the pair of transport rollers 73 in the paper transport direction, and the switching gate G2 is disposed at a branch point.

The switching gate G2 switches the second transport path S2 to a third transport path S3 for guiding to the pair of second ejection rollers 81 and a fourth transport path S4 for guiding to the pair of third ejection rollers 82 (refer to arrows in FIG. 2).

In the ejection tray T2, the paper P is accommodated with the image recording surface down (face down). In the ejection tray T3, the paper P is accommodated with the image recording surface up (face up).

A fifth transport path S5 is formed downstream of the pair of transport rollers 74 in the paper transport direction. The fifth transport path S5 is switched to the fourth transport path S4 on the ejection side of the pair of transport rollers 74 by a switching gate G3, and at the time of the double-sided printing, guides the paper P which is reversed to be transported once after being transported to the third transport path S3 to a reversal transport path S6 (refer to FIG. 1).

(2.2) Formation of Paper Transport Path

The second transport path S2 is formed of a part of a paper guide surface 75a of the guide 75 and a lower guide 77 forming one of the paper guide surfaces of the third transport path S3. The third transport path S3 is formed of the guide 77, a first guide surface G2a of the switching gate G2, and an upper guide 78.

The fourth transport path S4 has an upstream portion that is located upstream of the pair of transport rollers 74 in the paper transport direction and formed of the paper guide surface 75a of the guide 75 and a second guide surface G2b of the switching gate G2, and also has a downstream portion that is located downstream of the pair of transport rollers 74 in the paper transport direction and formed of a first guide surface G3a of the switching gate G3 and the upper guide 78.

The fifth transport path S5 has an upstream portion formed of the paper guide surface 75a of the guide 75 and the second guide surface G3b of the switching gate G3, and also has a downstream portion formed of the paper guide surface 75a of the guide 75 and the paper guide surface 76a of the second guide 76.

The guide 75 includes driven rollers 73b and 74b supported so as to protrude from the paper guide surface 75a which is entirely curved in a sectional view.

The driven roller 73b is rotatably press-contacted with the drive roller 73a forming the pair of transport rollers 73 so that the paper P is transported to the second transport path S2 with the nip portion interposed therebetween. A driven roller 74b is rotatably press-contacted with the drive roller 74a forming the pair of transport rollers 74 so that the paper P is transported from the second transport path S2 with the nip portion interposed therebetween to the fourth transport path S4, and at the time of the double-sided printing, the reversed paper P is transported from the third transport path S3 to the fifth transport path S5.

(2.3) Opening of Paper Transport Path

As illustrated in FIG. 3, the guide 75 rotates around a support shaft 75b as an example of a rotation shaft as rotation center so as to open the second transport path S2, the fourth transport path S4, and the fifth transport path S5.

The support shaft 75b, which is the center of rotation, is provided upstream of the second transport path S2, which is a part of the paper transport path, in the direction of transport of the paper, and extends to a lower portion of the guide 75 in the direction intersecting with the direction of transport of the paper.

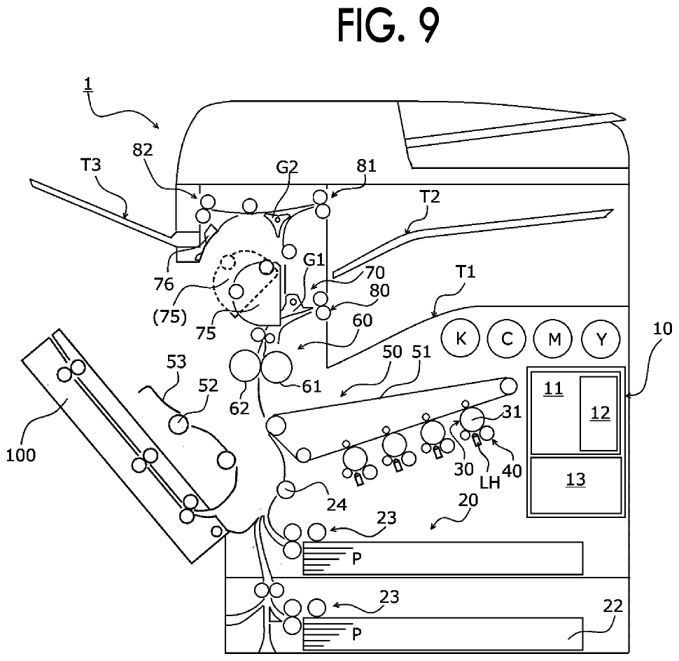

With this, the guide 75 rotates to move in the direction of transport of the paper around the support shaft 75b as the rotation center along with the opening and closing of an opening and closing member 100 (refer to FIG. 9), and when the guide 75 rotates in an opening posture, the guide surface of the second transport path S2, the fourth transport path S4, and the fifth transport path S5 are opened so as to widen the intervals of the guide faces (refer to an arrow R1 in FIG. 3).

When the guide 75 rotates in the opening posture, the nip between the pair of transport rollers 73 and 74 is released, and as schematically illustrated in FIG. 3B, the driven rollers 73b and 74b are greatly separated from the drive rollers 73a and 74a (refer to L1 in FIG. 3B).

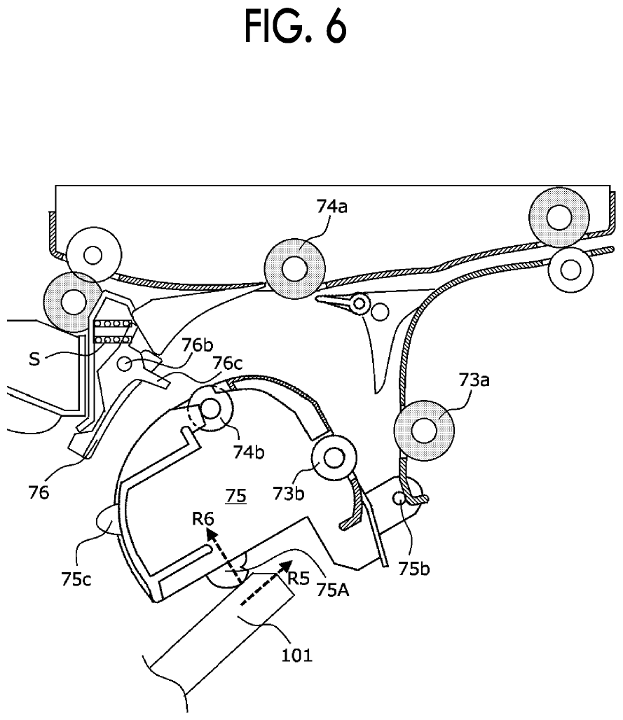

In addition, as illustrated in FIG. 6, when the guide 75 rotates into the opening posture along with the opening and closing of the opening and closing member 100, one end of the second guide 76 is pressed by a pressing spring S, and thus the second guide 76 also moves around the rotation shaft 76b as the rotation center (refer to an arrow R2 in FIG. 3) to be away from the guide 75 so that the distance from the paper guide surface 75a of the guide 75 increases.

(2.4) Closing of Paper Transport Path

As illustrated in FIG. 4A, the guide 75 rotates around the support shaft 75b as an example of a rotation shaft as rotation center (refer to an arrow R3 in FIG. 4A) so as to close the second transport path S2, the fourth transport path S4, and the fifth transport path S5.

When the guide 75 rotates toward the guide posture, the state where the drive rollers 73a and 74a and the driven rollers 73b and 74b of the pair of transport rollers 73 and 74 are greatly separated from each other is changed to a state where the driven rollers 73b and 74b move to be close to the drive rollers 73a and 74a (refer to an arrow R4 in FIG. 4B). At this time, since the support shaft 75b corresponding to the rotation center is provided to extend to the lower portion of the guide 75 in the direction intersecting with the direction of transport of the paper, driven rollers 73ba and 74ba on the front side (Y direction) and driven rollers 73bb and 74bb (−Y direction) on the back side move in parallel with the drive rollers 73a and 74a (distance L2 in FIG. 4B).

As illustrated in FIG. 5A, when the guide 75 rotates in the position of the guide posture, as illustrated in FIG. 5B, the drive rollers 73a and 74a and the driven rollers 73b and 74b of the pair of transport rollers 73 and 74 are brought into contact with each other, and thereby the paper can be transported.

At this time, since the support shaft 75b corresponding to the rotation center is provided to extend to the lower portion of the guide 75 in the direction intersecting with the direction of transport of the paper, the driven rollers 73ba and 74ba on the front side (Y direction) and the driven rollers 73bb and 74bb (−Y direction) on the back side are brought into contact with the drive rollers 73a and 74a at substantially the same timing. As a result, variations in the difference in nip pressure between the pair of transport rollers 73 and 74 on the front side and back side can be suppressed in the direction (width direction of the paper) intersecting with the paper transport direction, and thereby the paper can be stably transported.

(3) Removing Operation of Jammed Paper

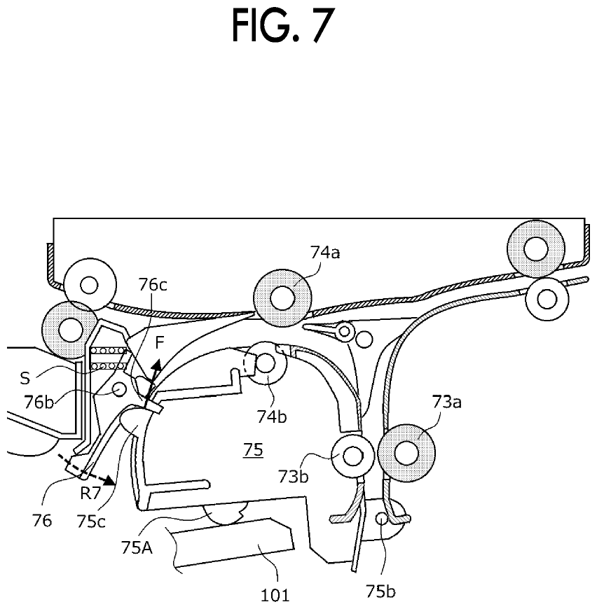

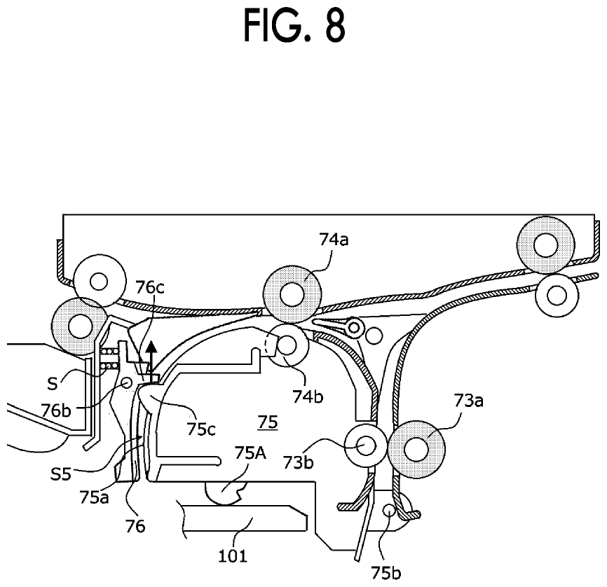

FIG. 6 is a schematic sectional view illustrating a movement start position in a case where the guide 75 is moved to the guide posture, FIG. 7 is a schematic sectional view illustrating a state where the guide 75 comes into contact with the second guide 76 to return the second guide 76 to the guide position, FIG. 8 is a schematic sectional view illustrating a state where the guide 75 and the opening and closing member 100 are engaged with an apparatus main body, and FIG. 9 is a schematic sectional view of an image forming apparatus 1 in which the guide 75 is positioned in the opening posture by opening the opening and closing member 100.

A jam removing operation in the image forming apparatus 1 will be described below with reference to the drawings.

(3.1) Removing Operation of Jammed Paper

As illustrated in FIG. 9, when the opening and closing member 100 of the apparatus main body is opened so that the inside of the apparatus main body is exposed, the paper transport path extending to the pair of registration rollers 24, the secondary transfer roller 52, and the transport guide 53 on the apparatus main body side and the paper transport device 70 disposed downstream of the fixing device 60 in the paper transport direction are exposed in a state where the ejection tray T3 is fixed to the apparatus main body.

The guide 75 is rotatably supported on the apparatus main body by a support shaft 75b on the upstream side in the paper transport direction, and engaged with an engaging portion (not shown) provided on the apparatus main body to maintain the guide posture.

Then, when the engagement with the apparatus main body is released, the guide 75 is rotated to be in the opening position. Note that, as illustrated in FIG. 9, the guide 75 which is disengaged from the main body is be rotated by approximately 90 degrees (indicated by a solid line in FIG. 9) so as to move to a position where the second transport path S2, the fourth transport path S4, and the fifth transport path S5 are greatly opened (refer to FIG. 3A) from a state of being biased in the guide posture direction by a spring or the like (indicated by a broken line in FIG. 9).

When the guide 75 is in the opening posture, the second guide 76 also moves around the rotation shaft 76b as the rotation center to be away from the guide 75 so that the distance from the paper guide surface 75a of the guide 75 is increased (refer to FIG. 3A).

With this, the second transport path S2, the fourth transport path S4, and the fifth transport path S5 are greatly opened, and the lower guide 77 of the second transport path S2, the switching gate G2, the switching gate G3, and the second guide 76 are exposed so that the user who wants to remove the jammed paper can easily remove the jammed paper.

In addition, since the paper transport device 70 is exposed to be in the opening posture without moving the ejection tray T3 on which the paper P is placed, a mechanism for holding the paper placed on the ejection tray T3 so as not to drop is not necessary, and thereby the size of the apparatus main body is reduced.

(3.2) Closing Operation of Paper Transport Device

For example, when the opening and closing member 100 rotates to be closed after completing the jam removing operation, as illustrated in FIG. 6, an engaged portion 101 (schematically illustrated in FIG. 6) provided in the opening and closing member 100 comes into contact with an engaging portion 75A (refer to an arrow R5 in FIG. 6) provided on the lower side of the guide 75 so that the guide 75 moves upward (refer to an arrow R6 in FIG. 6) rotating around the support shaft 75b as a rotation center.

When the closing operation of the opening and closing member 100 is continued, as illustrated in FIG. 7, the guide 75 rotates to move further upward, and a convex portion 75c provided on both side portions of the guide 75 comes into contact with an arm portion 76c formed on both side portions of the second guide 76. When the arm portion 76c is pressed by the convex portion 75c (refer to an arrow F in FIG. 7) provided on both side portions of the guide 75, the second guide 76 rotates against the biasing force of the pressing spring S and approaches the guide 75.

As illustrated in FIG. 8, when the opening and closing member 100 is closed and the guide 75 is positioned in the guide posture, the arm portion 76c is pressed by the convex portion 75c provided on both side portions of the guide 75 (refer to the arrow F in FIG. 8), and the fifth transport path S5 is formed to face the paper guide surface 75a of the guide 75 with a predetermined gap in the second guide 76.

In this state, as described above, the driven rollers 73ba and 74ba on the front side (Y direction) and the driven rollers 73bb and 74bb (−Y direction) on the back side of the pair of transport rollers 73 and 74 are brought into contact with each other in parallel with the drive rollers 73a and 74a so that the variations in the difference in nip pressure between the pair of transport rollers 73 and 74 on the front side and back side can be suppressed in the direction (width direction of the paper) intersecting with the paper transport direction (refer to FIG. 5B).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A paper transport device comprising:
a paper transport path that includes a plurality of pairs of transport units provided in a direction intersecting with a direction of transport of paper, and transports paper in a predetermined direction;
an opening and closing unit that is opened and closed to expose a part of the paper transport path; and
a guide unit that has a guide surface on one side of the paper transport path and is rotatably supported about a rotation shaft between a guide posture for guidance of the paper and an opening posture for opening of the guide surface through rotation from the guide posture, when the opening and closing unit is opened.

2. The paper transport device according to claim 1, wherein
the rotation shaft is provided upstream of the paper transport path in the direction of transport of the paper and extends to a lower portion of the guide unit in a direction intersecting with the direction of transport of the paper, and
the guide unit rotates in the direction of transport of the paper around the rotation shaft as a rotation center along with opening and closing of the opening and closing unit.

3. The paper transport device according to claim 1, wherein
the guide unit holds a driven roller that protrudes from the guide surface and constitutes one side of the pair of transport units, rotates around the rotation shaft as a rotation center by an operation of closing the opening and closing unit, and brings a plurality of the driven rollers into contact with a plurality of drive rollers constituting another side of the pair of transport units.

4. The paper transport device according to claim 1, further comprising:
a second guide unit that faces the guide surface of the guide unit and forms one side of a reversal transport path that allows reverse transport of the paper in the paper transport path,
when the opening and closing unit is opened, the second guide unit moves to be away from the guide unit and to increase a distance between the second guide unit and the guide surface of the guide unit.

5. The paper transport device according to claim 4, wherein
each of the guide unit and the second guide unit has a protrusion, and
operation of closing the opening and closing unit allows the protrusion of the guide unit to come into contact with the protrusion of the second guide unit and allows the guide unit and the second guide unit to move and form the paper transport path.

6. An image forming apparatus comprising:
an image forming unit that forms an image on paper;
an ejection unit that ejects the paper on which the image is formed by the image forming unit;
the paper transport device according to claim 1 that transports the paper on which the image is formed by the image forming unit to the ejection unit; and
an opening and closing unit that is opened and closed to expose a part of the paper transport path of the paper transport device.
